(19) United States
(12) Patent Application Publication
(10) Pub. No.: US 2007/0280812 A1
(43) Pub. Date: Dec. 6, 2007

(54) Tool and method for mixed palletizing/depalletizing

(75) Inventors: Sylvain-Paul Morency, Laval (CA); Jean-Francois Forget, Montreal (CA); Pascal Jubinville, Terrebonne (CA)

Correspondence Address: VENABLE LLP, P.O. BOX 34385, WASHINGTON, DC, 20043-9998, US

(73) Assignee: AXIUM Inc., Montreal (CA)

(21) Appl. No.: 11/798,910

(22) Filed: May 17, 2007

Related U.S. Application Data
(60) Provisional application No. 60/747,421, filed on May 17, 2006.

(51) Int. Cl. B66C 3/00

(52) U.S. Cl. 414/729

(57) ABSTRACT

A material handling tool comprising a longitudinal body provided with a proximate end and a distal end is described herein. The handling tool includes a vacuum jaw assembly so mounted to the distal end of the body as to be transversally movable; and a longitudinally movable jaw assembly so mounted to the longitudinal body as to be longitudinally movable between a retracted position where the movable jaw assembly is adjacent to the longitudinal body and an extended position where the movable jaw assembly faces the vacuum jaw assembly.

### CROSS-REFERENCE TO RELATED APPLICATION

This application claims the benefit of U.S. Provisional Application No. 60/747,421, filed May 17, 2006, the subject content of which is incorporated herein by reference.

### SUMMARY OF THE INVENTION

The present invention generally relates to material handling. More specifically, the present invention is concerned with a tool and method for mixed palletizing/depalettizing. Manufacturing robots are a common sight in industrialized manufacturing sites. They are used for many tasks such as painting, welding and material handling.

When used for material handling, manufacturing robots are generally provided with gripping tools that are configured to handle specific materials having specific shapes.

When such robots are used for palletizing/depalletizing box-shaped objects, the gripping tool generally consists in parallel jaws that may be moved toward each other to grab the object. This has many drawbacks, often associated with the separation of adjacent objects and the determination of the objects size and orientation.

### BRIEF DESCRIPTION OF THE DRAWINGS

In the appended drawings:

FIG. 1 is a side elevation view of a manufacturing robot provided with a material handling tool according to a first illustrative embodiment of the present invention;

FIG. 2 is a perspective view of a material handling tool to the first illustrative embodiment of the present invention; shown with one side open;

FIG. 3 is a side elevation view of the material handling tool of FIG. 2; the tool being shown with its vacuum jaw in a fully extended position and its horizontally movable jaw in a retracted position;

FIG. 4 is a side elevation view similar to FIG. 3 but illustrating the vacuum jaw in its gripping position and the horizontally movable jaw in its extended position;

FIG. 5 is a perspective view of the tool of FIG. 2, showing the vacuum pad of the vacuum jaw;

FIGS. 6A to 6E illustrate the steps of a depalletizing method according to an illustrative aspect of the present invention;

FIGS. 7A to 7D illustrate an alternative beginning of the depalletizing method of FIGS. 6A-6E;

FIGS. 8A-8E illustrate the steps of a palletizing method according to an illustrative aspect of the present invention;

FIG. 9 is a perspective view of a material handling tool according to a second illustrative embodiment of the present invention;

FIG. 10A-10F illustrate the steps of a depalletizing method according to an illustrative aspect of the present invention; the depalletizing method using the material handling tool of FIG. 9;

FIG. 11A-11E illustrate the steps of a palletizing method according to an illustrative aspect of the present invention; the palletizing method using the material handling tool of FIG. 9; and

FIG. 12 is a perspective view of a material handling tool according to a third illustrative embodiment of the present invention.

### DETAILED DESCRIPTION

In accordance with a first aspect of the present invention, there is provided a material handling tool comprising a longitudinal body provided with a proximate end and a distal end; a vacuum jaw assembly so mounted to the distal end of the body as to be transversally movable; the vacuum jaw assembly including a first jaw member provided with a first object contacting surface having at least one vacuum suction aperture; and a longitudinally movable jaw assembly including a second jaw member provided with a second object contacting surface; the second jaw member being so mounted to the longitudinal body as to be longitudinally movable between a retracted position where the second object contacting surface is adjacent to the longitudinal body and an extended position where the second object contacting surface faces the first object contacting surface.

In accordance to a second illustrative embodiment of the present invention there is provided a method to extract from a pallet a first boxed-shaped object provided with two opposite and generally parallel sides using a material handling tool provided with a longitudinal body, a transversally movable vacuum jaw assembly mounted to the body and a longitudinally movable jaw assembly so mounted to the body as to be movable between a retracted position and an extended position where the longitudinally movable jaw assembly faces the vacuum jaw assembly, the method comprising: i) contacting one of the two opposite sides with the transversally movable vacuum jaw assembly; ii) applying a vacuum between the vacuum jaw assembly and the one of the two opposite sides; iii) moving the longitudinally movable jaw assembly from the retracted position to the extended position where the longitudinally movable jaw assembly is generally parallel to the other of the two opposite sides; iv) transversally moving the vacuum jaw assembly to force a contact between the longitudinally movable jaw assembly and the other of the two opposite sides; and v) moving the body of the tool to thereby extract the first boxed-shaped object maintained between the jaw assemblies.

According to a third aspect of the present invention, there is provided a method to position a boxed-shaped object in a pallet including at least two adjacent boxed-shaped objects each provided with two opposite and generally parallel sides; the method using a material handling tool provided with a longitudinal body, a transversally movable vacuum jaw assembly mounted to the body and a longitudinally movable jaw assembly so mounted to the body as to be movable between a retracted position and an extended position where the longitudinally movable jaw assembly faces the vacuum jaw assembly, the method comprising gripping the boxed-shaped object to be positioned between the vacuum jaw assembly and the longitudinally movable jaw assembly; one of the two opposite sides being contacted by the vacuum jaw assembly and maintained thereon by a vacuum, and the other of the two opposite sides being contacted by the longitudinally movable jaw; moving the body of the tool so as to generally position the boxed-shaped object in the desired position in the pallet; transversally moving the vacuum jaw assembly to force a separation between the longitudinally movable jaw assembly and the other of the two opposite sides; moving the longitudinally movable jaw assembly from the extended position to the retracted position; moving the body of the tool to thereby position the boxed-shaped object adjacent to other boxed-shaped object; removing the vacuum between the vacuum jaw assembly and the one of the two opposite sides; and moving the body of the tool away from the positioned boxed-shaped object.

Other objects, advantages and features of the present invention will become more apparent upon reading of the following non-restrictive description of illustrative embodiments thereof, given by way of example only with reference to the accompanying drawings.

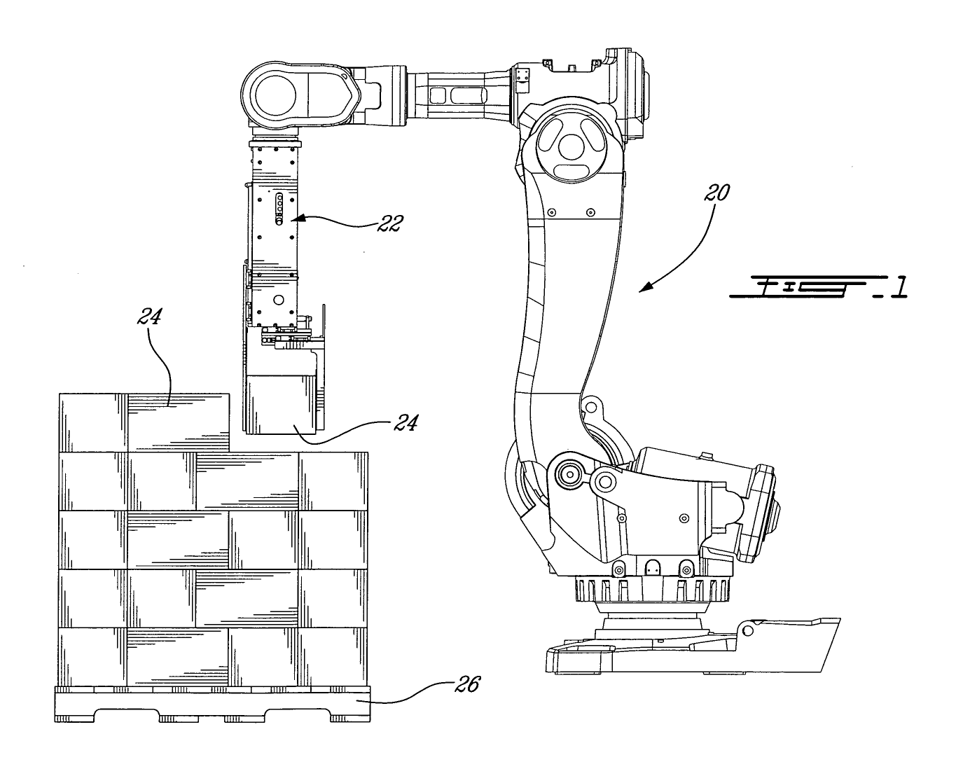

FIG. 1 of the appended drawings illustrates an industrial robot 20 provided with a material handling tool 22 according to a first illustrative embodiment of the present invention. The material handling tool 22 is so sized as to manipulate boxes 24 to be moved to or from a pallet 26.

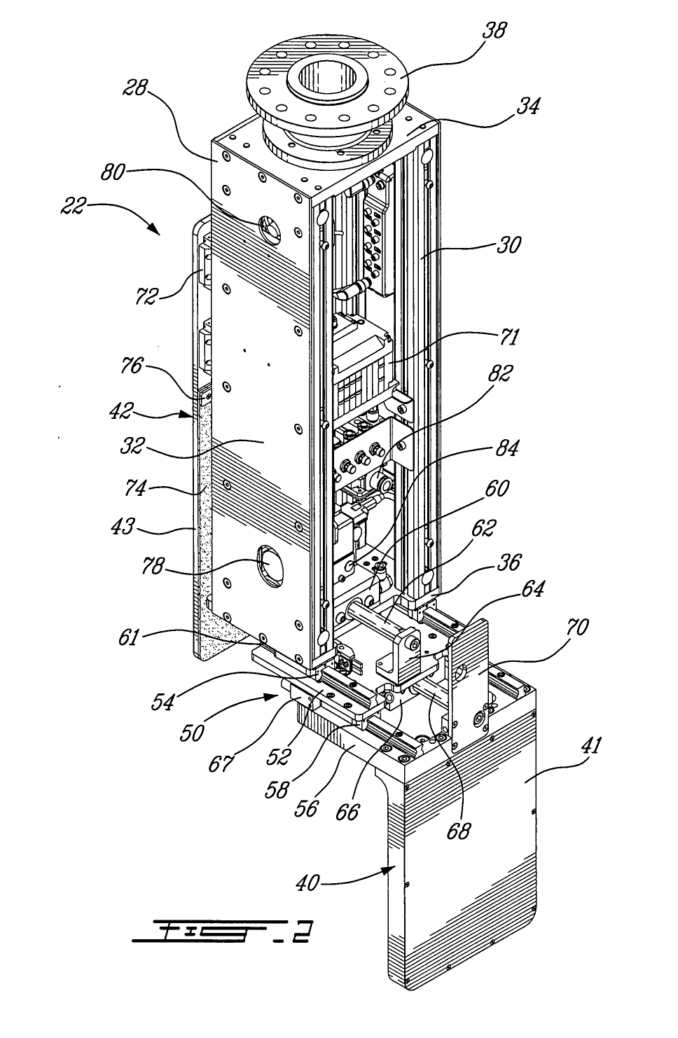

Turning now to FIGS. 2 to 5, the material handling tool 22 according to a first embodiment of the present invention will be described.

The tool 22 includes a body 28 provided with a frame made of extruded profiles 30, flat plate sides 32, a top plate 34 defining a proximate end of the body 28 and a bottom plate 36 defining the distal end of the body 28. The body 28 houses the electronic and mechanical components used to operate the tool 22 as will be discussed hereinbelow.

A robot-mounting flange 38 is mounted to the top plate 24 to connect the tool to the robot 20.

The tool 22 further includes a transversally movable vacuum jaw assembly 40 and a longitudinally movable jaw assembly 42.

As can be better seen from FIG. 5, the transversally movable jaw assembly 40 includes a vacuum jaw member 41 provided with an object contacting surface 44 that includes a plurality of vacuum suction apertures 46 that are operationally connected to a vacuum source (not shown) and sealing grids 48 that conventionally separate the apertures 46. The apertures 46 and the sealing grids 48 define a vacuum pad on the object contacting surface of the jaw member 41. The vacuum source (not shown) may be in the form of venturi vacuum generator pumps associated with each of the apertures 46 and connected to a source of compressed air (not shown). When such a vacuum source is used, exhaust apertures 47 are advantageously provided.

The sealing grids 48 could be made of a resilient deformable material such as, for example, closed cell foam.

Returning to FIG. 2, the vacuum jaw member 41 is mounted to the bottom plate 36 via a telescoping assembly 50 including a first sliding plate 52 mounted to the bottom plate 36 via two slide assemblies 54 and a second sliding plate 56 mounted to the first sliding plate 52 via two slide assemblies 58. The vacuum jaw member 41 is fixedly mounted to the second sliding plate 56.

Two pneumatic actuators are provided to move the vacuum jaw member 41. A first actuator 60 is located inside the body 28 and includes a piston 60 connected to the first sliding plate 52 via a bracket 64. A second actuator 66 is located between the first and second sliding plates 52, 56 and includes a piston 68 connected to the second sliding plate 56 via a flat bracket 70. The flat bracket 70 further acts as a target for the analog distance sensor 84 as will be described hereinbelow. As can be seen from FIG. 2, the second sliding plate 56 is partially hollowed to accommodate the pneumatic actuator 66 while optimizing the distance between the first and second sliding plates 52 and 56.

The first and second actuators 60, 66 may therefore transversally move the vacuum jaw member 41 under the control of a controller 71.

Two pneumatic brakes are also provided to prevent further sliding movements of the sliding plates 52 and 56 when a desired position is reached as will be described hereinbelow. A first pneumatic brake 61 is mounted to the first sliding plate 52 while a second pneumatic brake 67 is mounted to the second sliding plate 56.

The longitudinally movable jaw assembly 42 includes a jaw member 43 which is slidably mounted to the body 28 of the tool 22 via a pair of sliding assemblies 72. The jaw member 43 is actuated via a pneumatic actuator (not shown) provided in the body 28.

The object contacting surface of the jaw member 43 is defined by a friction pad 74 secured thereto via a friction pad securing bracket 76 so as to enable easy replacement of the friction pad 74.

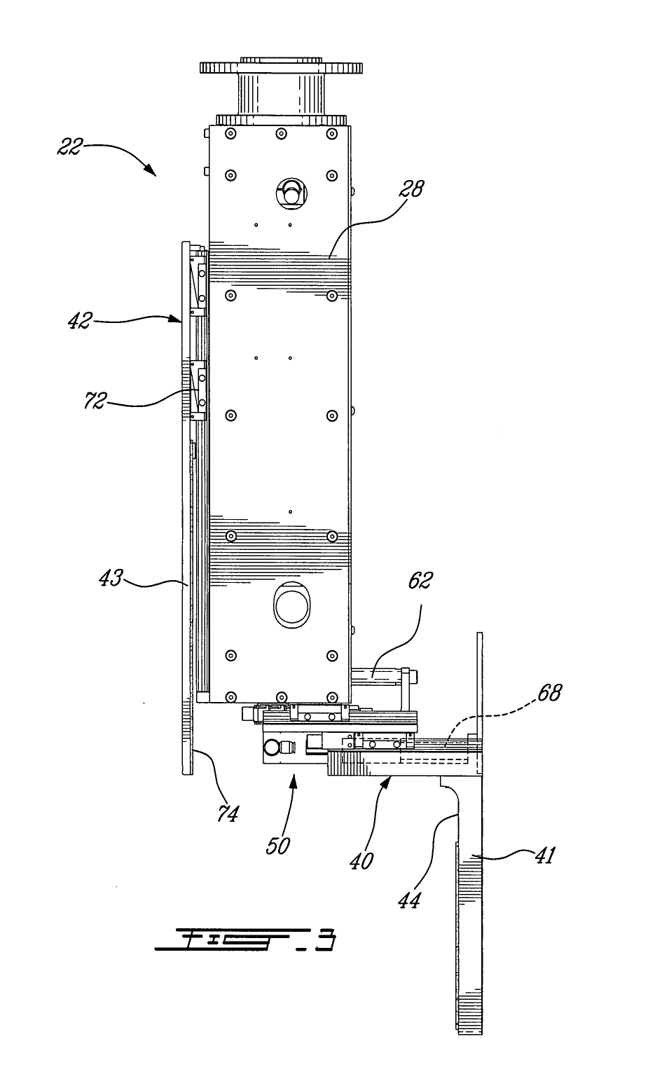

The jaw member 43 is thus reciprocately movable between a retracted position illustrated in FIG. 3 where the jaw member 43 is adjacent to the body 28 of the tool 22 and an extended position illustrated in FIG. 4 where the object contacting surface of the jaw member 43, i.e. the friction pad 74 generally faces the object contacting surface 44 of the jaw member 41.

The tool 22 also includes an area scan camera 78, a laser sensor 80, an analog pressure regulator 82 and an analog distance sensor 84 to supply data to the controller (not shown). It is believed within the reach of one skilled in the art to acquire data from the area scan camera 78 and from the laser sensor 80 to properly control the tool 22 to grab the desired object. For example, the area scan camera 78 and the laser sensor 80 may scan each layer of a pallet to determine the coordinates and the orientation of all the different boxes forming the pallet and supply this information to the robot 20.

FIG. 3 of the appended drawings illustrate the tool 22 with the vacuum jaw assembly 40 in its fully extended position, i.e. when both actuators 60 and 66 have their respective pistons 62 and 68 in their extended position. In this figure, the horizontally movable jaw assembly 42 is illustrated in its retracted position.

On the other hand, FIG. 4 illustrates the tool 22 with the vacuum jaw assembly 40 in its fully retracted position, i.e. the object gripping position, and the horizontally movable jaw assembly 42 in its extended position.

As can be seen from FIG. 2, the tool 22 also includes various elements mounted in the body 28 such as regulators, valves, electronic circuits, limit switches and the like to control the operation of the tool 22. Since these elements are specific to the application and believed to be within the reach of one skilled in the art, they will not be further discussed herein.

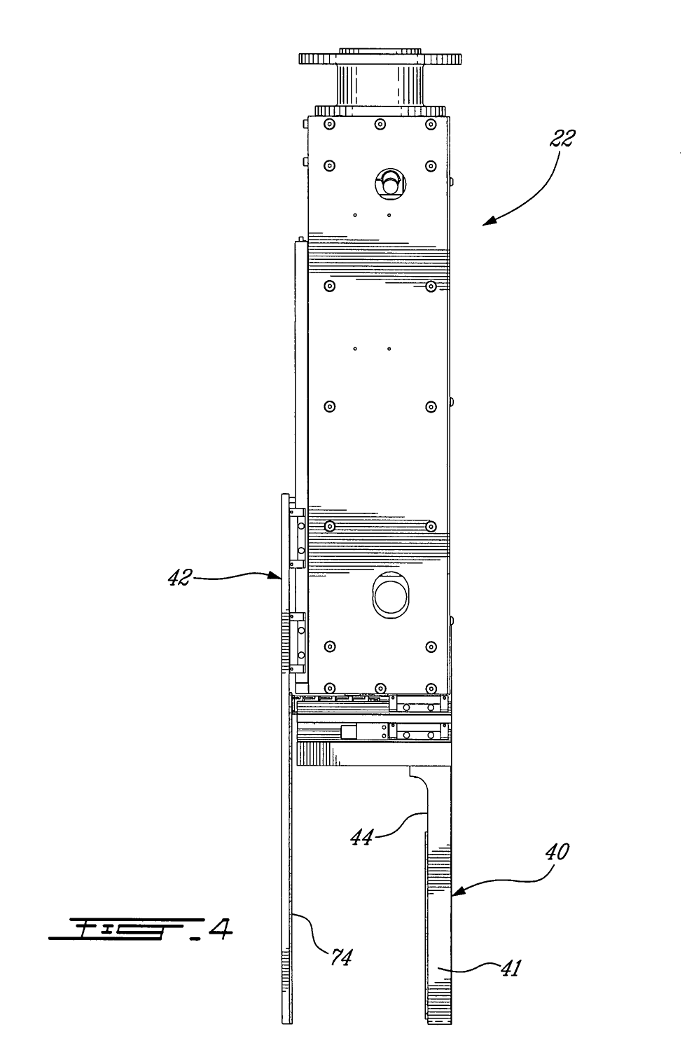

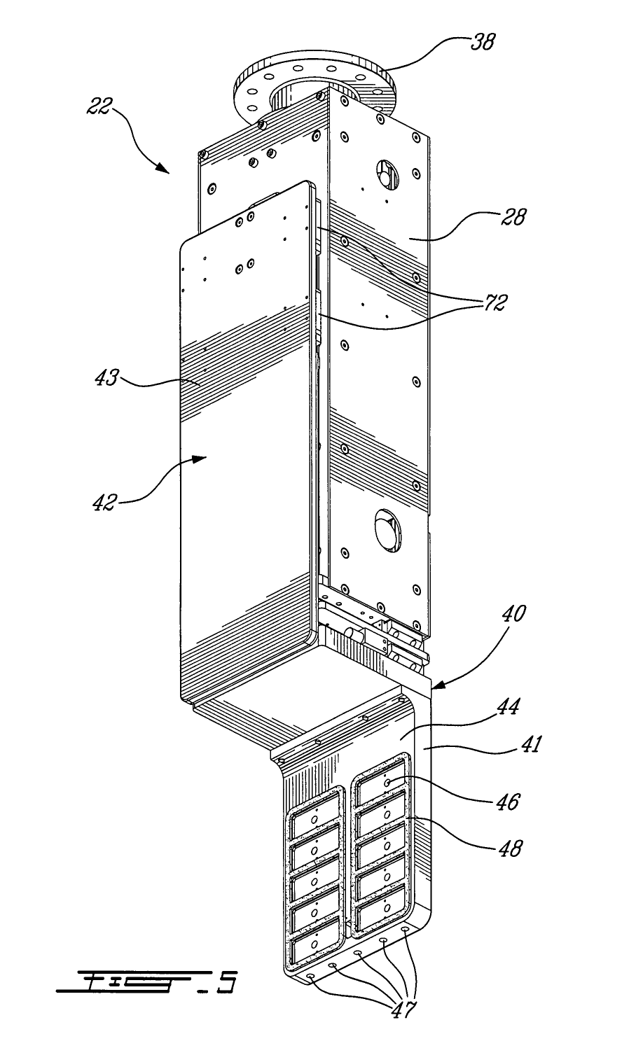

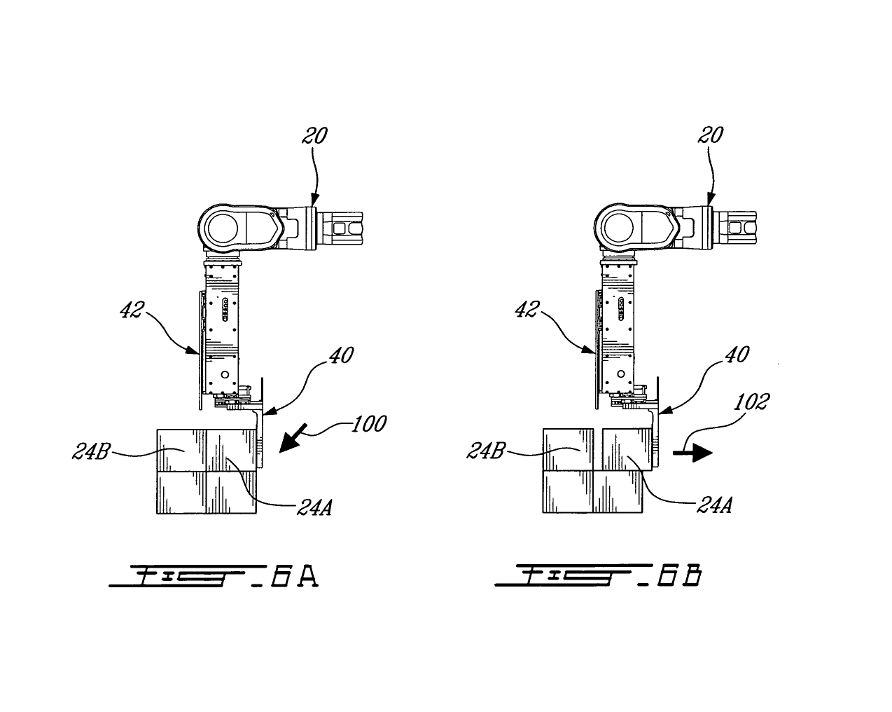

Turning now to FIGS. 6A to 6E a depalettizing method according to an illustrative aspect of the present invention will be described.

The first step of the method consists in the approach and is illustrated in FIG. 6A. The vertically movable jaw assembly 42 is in its retracted position and the vacuum jaw assembly 40 is in its extended position. The distance between the two jaw assemblies 40-42 is generally equal to the width of the box 24A to be grabbed plus about one inch (about 2.5 cm). The robot 20 sticks the vacuum pad on the accessible side of the box 24A. As shown from the arrow 100, the approach of the tool 22 controlled by the robot 20 is in an angled direction.

The next step, shown in FIG. 6B, is the box separation. To achieve this, the vacuum source (not shown) is activated, adequately securing the box 24A to the jaw assembly 40. The robot 20 pulls the box 24A to create room between boxes 24A and 24B (see arrow 102).

Then, as can be seen from FIG. 6C, the vertically movable jaw 42 is extended (see arrow 104) in the gap created between boxes 24A and 24B.

FIG. 6D illustrates the gripping of the box 24A between the jaws 40, 42. More specifically, the jaw 40 is moved towards the jaw 42 (see arrow 106) until the box 24A is securely gripped therebetween. The pressure regulator 82 and the distance sensor 84 (FIG. 2) are used to determine the distance between the jaws and the gripping force applied to the box 24A. It is to be noted that when the desired gripping force is applied to the box 24A, the pneumatic brakes 61 and 67 are activated to prevent further sliding movements of the jaw 40.

Finally, the robot 20 removes the box 24A from the pallet (see arrow 108 of FIG. 6E).

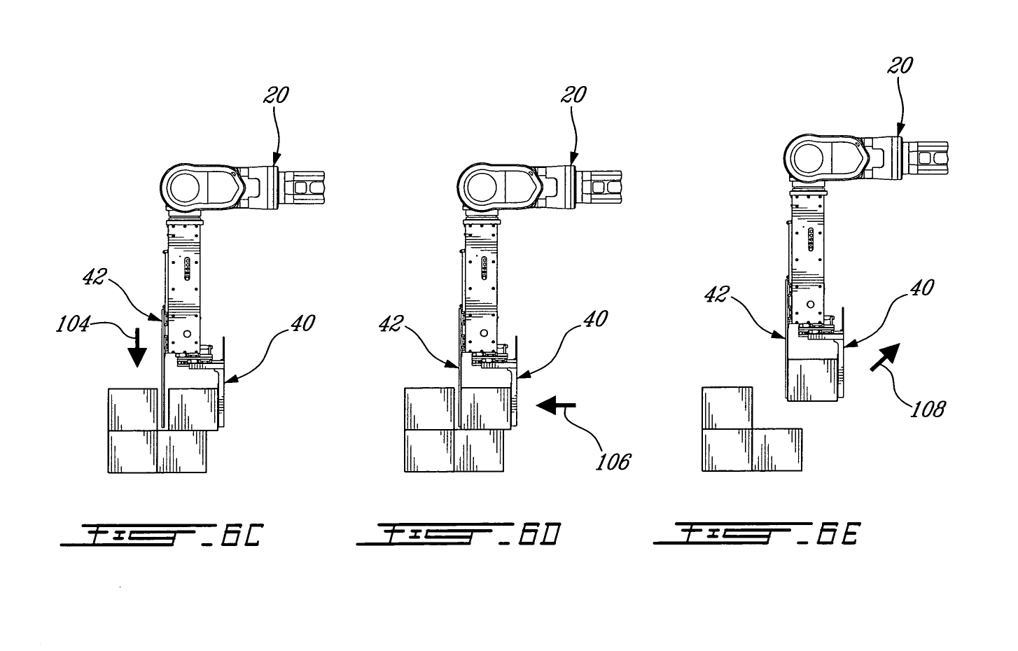

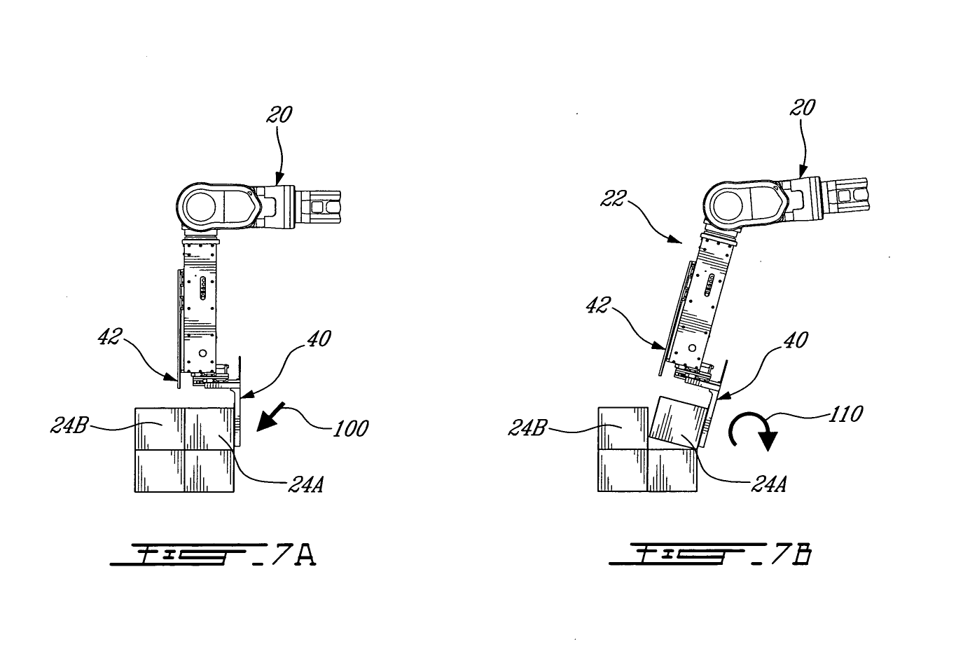

Turning now to FIGS. 7A to 7D, an alternative beginning of the depalettizing method discussed hereinabove will be described. Generally stated, the alternate beginning shown in these figures is used to break an adhesive bond that is sometimes used to maintain the palletized objects together.

FIG. 7A is the approach step which is identical to FIG. 6A.

Then, in step 7B, the robot 20 tilts the tool 22 (see arrow 110). Since the vacuum source (not shown) is activated, this tilting motion tilts the box 24A.

FIG. 7C illustrates the lateral movement of the box 24A (see arrow 112) to create the desired gap between the boxes 24A and 24B.

Finally, the box 24A is tilted in its horizontal position (arrow 114 of FIG. 7D) and the box 24A and the tool 22 are in the same position as in FIG. 6B. The steps of FIGS. 6C to 6E can then be performed.

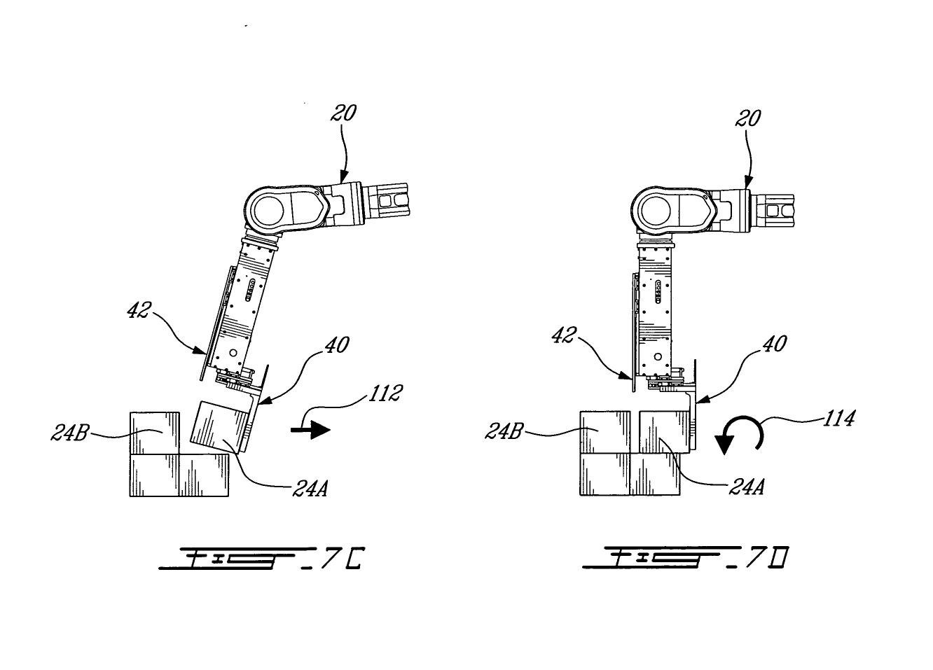

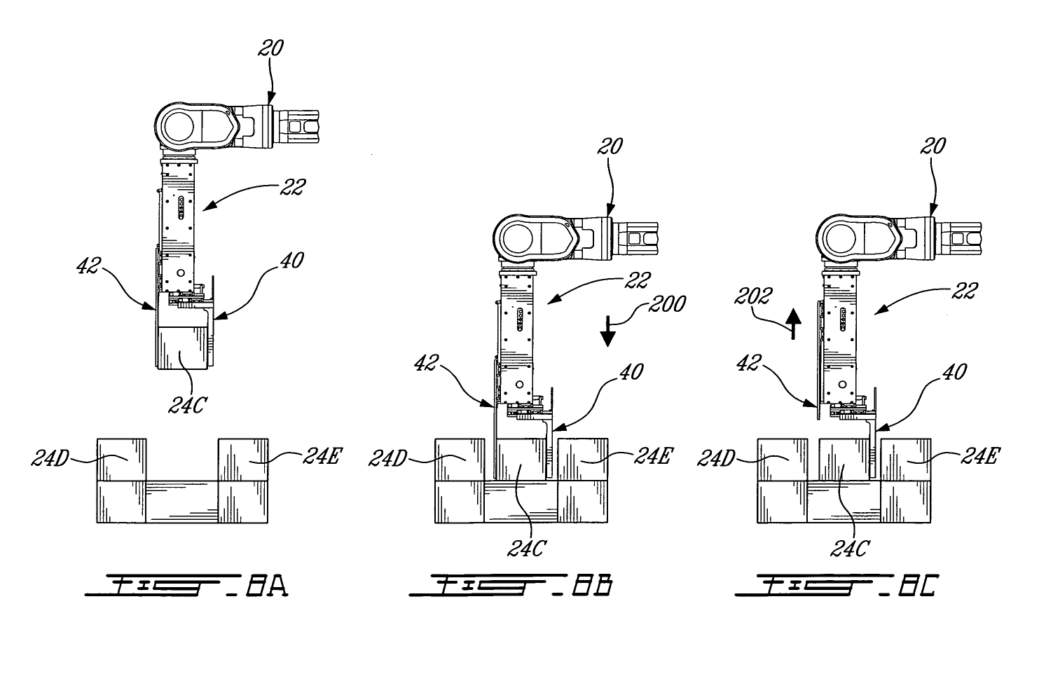

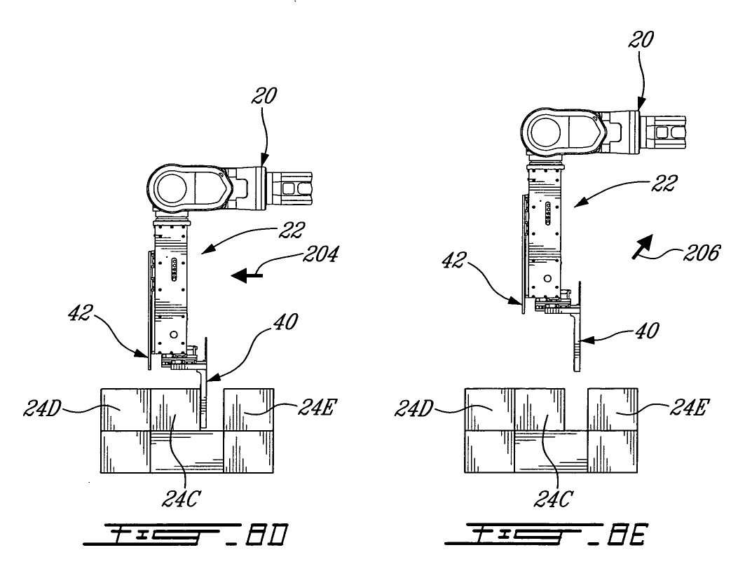

Turning now to FIGS. 8A to 8E of the appended drawings a pelletization method according to an illustrative aspect of the present invention will be described. This illustrated method describes the more complex situation where a box 24C must be palletized in an empty space between boxes 24D and 24E. The box 24C being initially held between the jaw assemblies 40 and 42 of the tool 22.

First, the robot 20 positions the box 24C above the empty area where the box 24C is to be palletized, as can be seen in FIG. 8A.

The box 24C is then lowered (see arrow 200 in FIG. 8B) by the robot 20 in the empty space between boxes 24D and 24E.

The box 24C is then released from the tool 22. More specifically, the vacuum source (not shown) is deactivated and the vertically movable jaw assembly 42 is moved to its retracted position (see arrow 202 of FIG. 8C).

As can be seen in FIG. 8D, to optimize the pallet, the robot 22 then pushes the box 24C (see arrow 204) against the box 24D to reduce the gap between these boxes.

Finally, the robot 20 moves away from the pallet (see arrow 206 of FIG. 8E).

Turning now to FIG. 9 of the appended drawings, a material handling tool 300 according to a second illustrative embodiment of the present invention will be described. It is to be noted that since the tool 300 is very similar to the tool 22 described hereinabove, only the differences between these tools will be described hereinbelow, for concision purpose.

Generally stated, the vacuum jaw assembly 302 of the tool 300 includes a first generally longitudinal jaw member 304 and a second generally transversal jaw member 306. The first jaw member 204 is identical to the jaw member 41 of the tool 22 and may move laterally as described hereinabove. On the other hand, the second jaw member 306 is so mounted to the slide plate 56 as to be longitudinally movable. Indeed, an actuator (not shown) is provided between the sliding plate 56 and the jaw member 306 to longitudinally move it.

The second jaw member 306 is used mainly to increase the holding capacity of the vacuum jaw assembly 302.

It is to be noted that the second jaw member also includes vacuum apertures 308 and sealing grids 310.

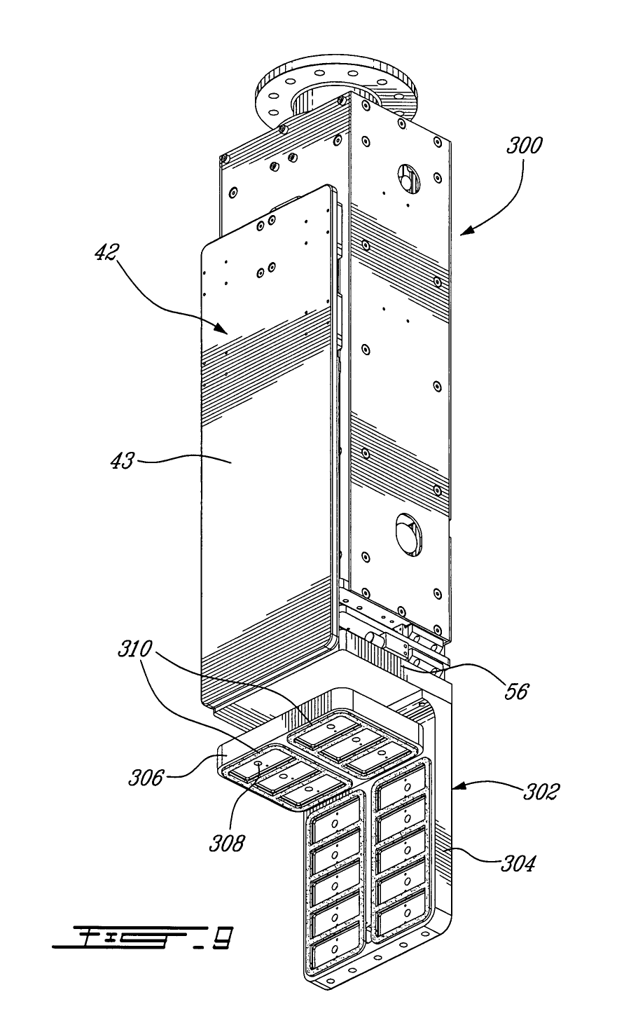

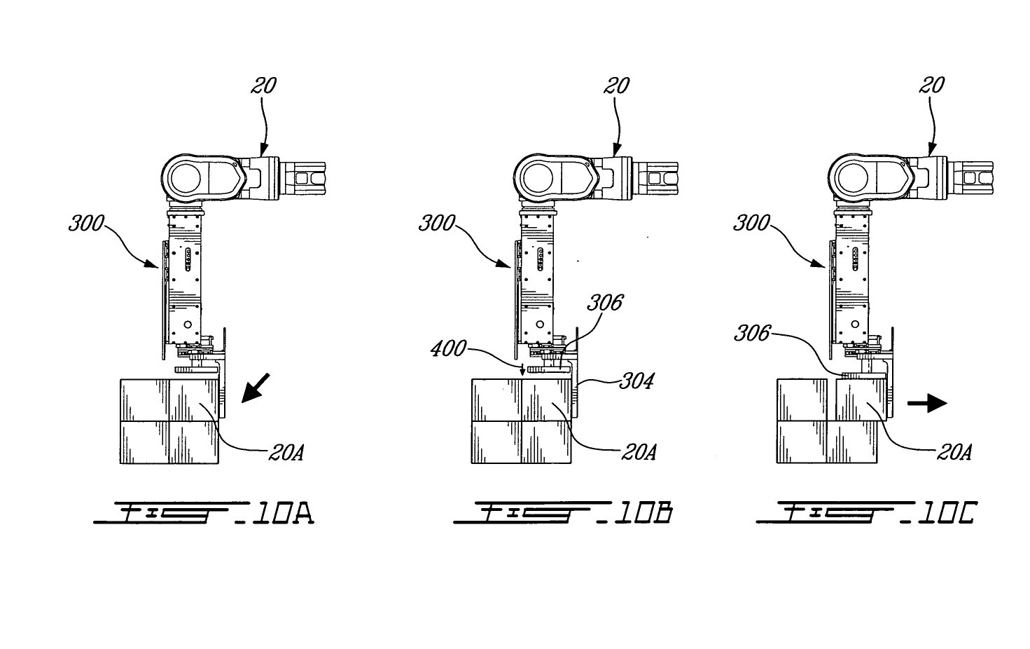

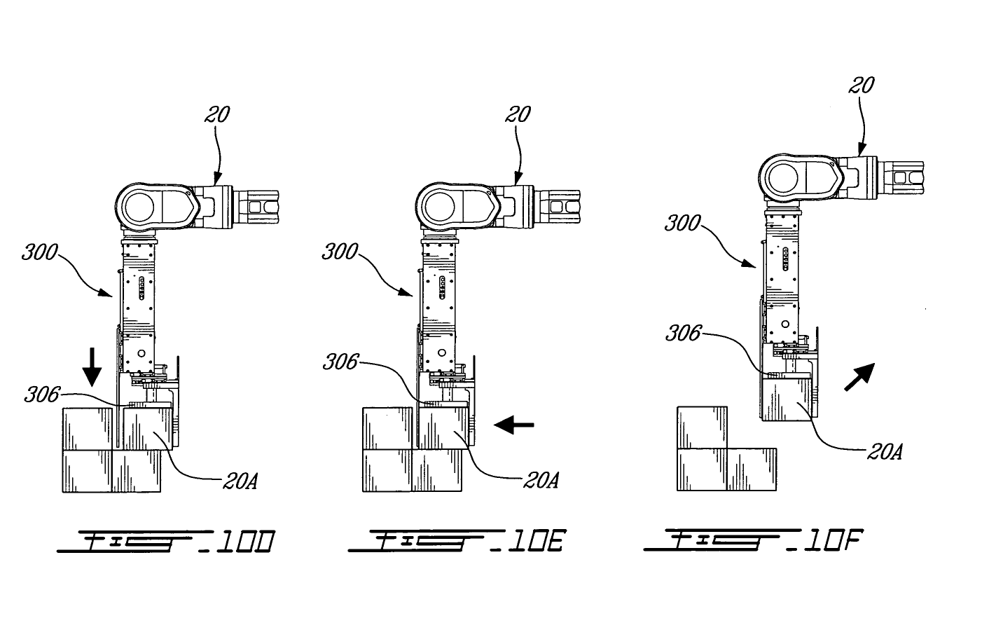

Turning now to FIGS. 10A to 10F, a depalletizing method using the tool of FIG. 9, according to an illustrative aspect of the present invention, will be described.

First, the approach of FIG. 10A is similar to the approach of FIG. 6A.

Then, as illustrated in FIG. 10B, the second vacuum jaw member 306 is longitudinally moved (see arrow 400) to contact the top of the box 20A. The vacuum source (not shown) is then activated, therefore securing the box 24A to both the jaw members 304 and 306.

FIGS. 10C to 10F generally correspond to FIGS. 6B to 6E and will therefore not be further described herein for concision purpose.

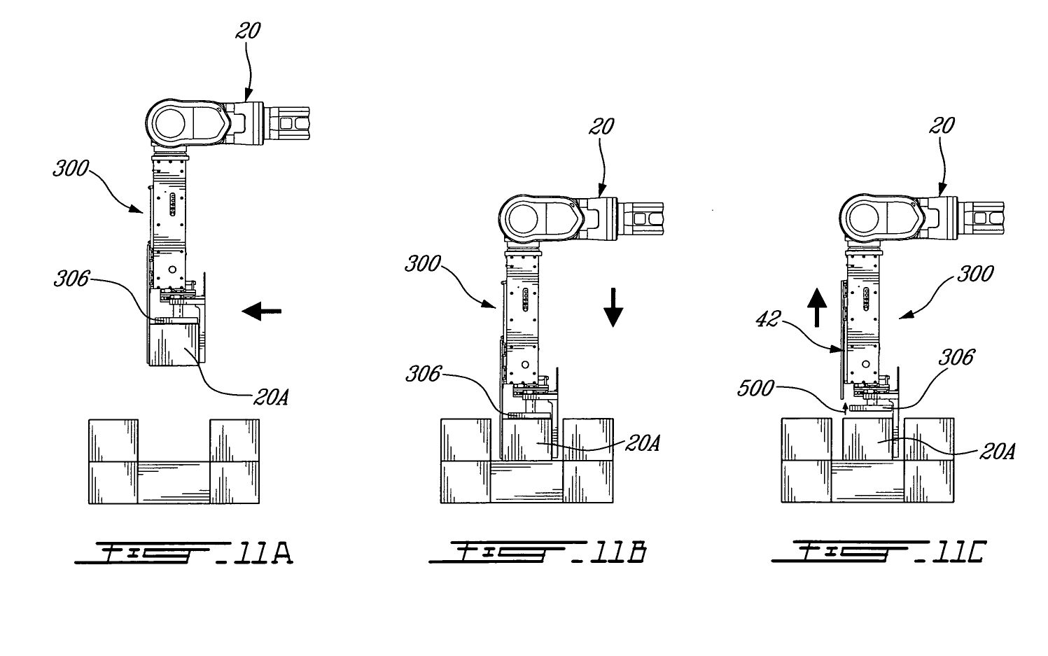

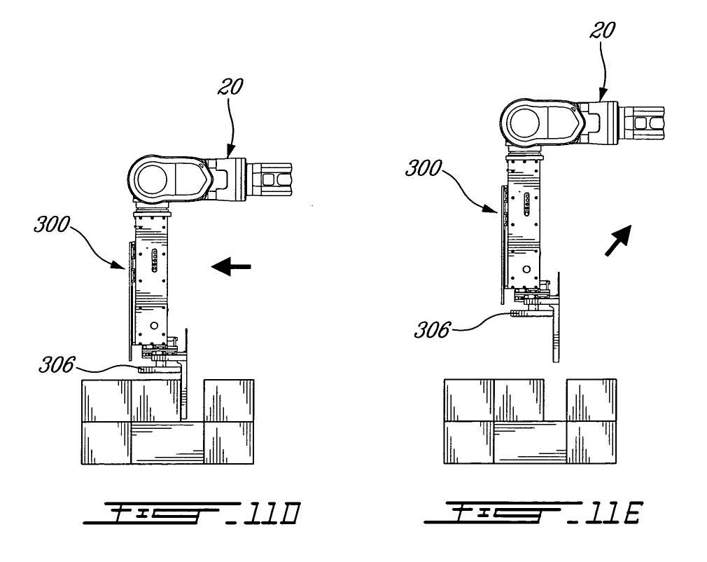

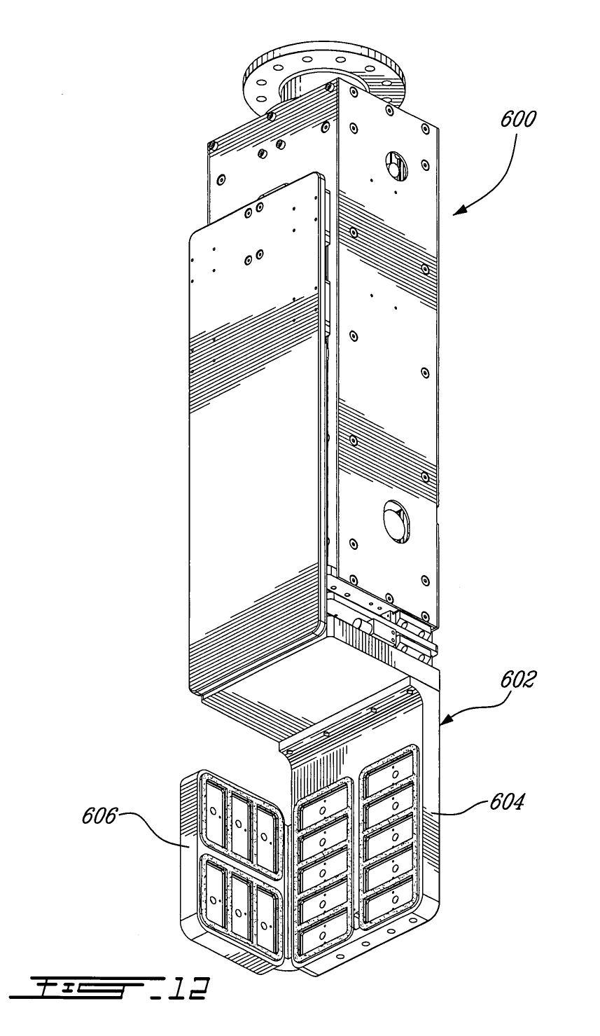

A palletizing method using the tool 300 of FIG. 9 will be described with references to FIGS. 11A to 11E. Since this palletizing method is very similar to the palletizing method of FIGS. 8A to 8E described hereinabove, only the differences between these methods will be described hereinbelow.

Generally stated, the main difference is illustrated in FIG. 11C where the second jaw member 306 is raised (see arrow 500) when the longitudinally movable jaw assembly 42 is moved towards its retracted position. The other steps of the method are essentially the same and will not be further discussed herein.

Turning finally to FIG. 12 of the appended drawings, a material handling tool 600 according to a third illustrative embodiment of the present invention will be described. It is to be noted that since the tool 600 is very similar to the tools 22 and 300 described hereinabove, only the differences between these tools will be described hereinbelow, for concision purpose.

Generally stated, the vacuum jaw assembly 602 of the tool 600 includes a first generally longitudinal jaw member 604 and a second generally longitudinal jaw member 606, the two jaw members 604 and 606 being generally at right angle. The jaw member 606 is so mounted to the jaw member 604 via an actuator (not shown) as to be movable in a lateral and perpendicular direction thereabout.

The second jaw member is used mainly to increase the holding capacity of the assembly 602.

The length of the body 28 allows the material handling tools 22, 300 and 600 to reach boxed-shaped objects that are relatively deeply positioned among other boxed-shaped objects.

It is to be noted that many modifications could be done to the above described illustrative embodiments. These modifications include, for example:
the size and configuration of the flange 38 could be modified to allow interconnection to other types of robots;
hydraulic cylinders and/or linear motors could be used instead of the pneumatic cylinders illustrated;
the size and number of the vacuum suction apertures 46 could vary;
the size and number of sliding plates and actuators could be configured depending of the size of the objects to be manipulated;
the material handling tools described hereinabove could also be mounted to a gantry or to other mobile structures provided with at least three (3) degrees of freedom; and
while palletizing and depalletizing operations have been described hereinabove, other material handling operations could be done by the material handling tools such as, for example handling different format generally boxed-shaped objects traveling of a conveyor.

It is to be understood that the invention is not limited in its application to the details of construction and parts illustrated in the accompanying drawings and described hereinabove. The invention is capable of other embodiments and of being practiced in various ways. It is also to be understood that the phraseology or terminology used herein is for the purpose of description and not limitation. Hence, although the present invention has been described hereinabove by way of illustrative embodiments thereof, it can be modified, without departing from the spirit, scope and nature of the subject invention as defined in the appended claims.

What is claimed is:

1. A material handling tool comprising:
a longitudinal body provided with a proximate end and a distal end;
a vacuum jaw assembly so mounted to the distal end of the body as to be transversally movable; the vacuum jaw assembly including a first jaw member provided with a first object contacting surface having at least one vacuum suction aperture; and
a longitudinally movable jaw assembly including a second jaw member provided with a second object contacting surface; the second jaw member being so mounted to the longitudinal body as to be longitudinally movable between a retracted position where the second object contacting surface is adjacent to the longitudinal body and an extended position where the second object contacting surface faces the first object contacting surface.

2. The material handling tool as recited in claim 1, wherein the proximate end of the longitudinal body includes a mounting flange.

3. The material handling tool as recited in claim 1, wherein the vacuum jaw assembly includes a telescoping assembly mounting the first jaw member to the distal end of the body.

4. The material handling tool as recited in claim 3, wherein the telescoping assembly includes a first sliding plate slidably mounted to the distal end of the body and a second sliding plate slidably mounted to the first sliding plate; the first jaw member being fixedly mounted to the second sliding plate.

5. The material handling tool as recited in claim 4, wherein the telescoping assembly includes a first pair of slides slidably mounting the first sliding plate to the distal end of the body and a second pair of slides slidably mounting the second sliding plate to the first sliding plate.

6. The material handling tool as recited in claim 5, wherein the telescoping assembly includes a first actuator so mounted between the distal end of the body and the first sliding plate to transversally move the first sliding plate and a second actuator so mounted between the first sliding plate and the second sliding plate as to transversally move the second sliding plate.

7. The material handling tool as recited in claim 6, wherein the first and second actuators are selected from the group consisting of pneumatic actuators, hydraulic actuators and linear motors.

8. The material handling tool as recited in claim 6, wherein the telescoping assembly includes a first brake selectively preventing the sliding movement of the first sliding plate and a second brake selectively preventing the sliding movement of the second sliding plate.

9. The material handling tool as recited in claim 1, wherein the at least one vacuum suction aperture includes a plurality of vacuum suction apertures.

10. The material handling tool as recited in claim 9, wherein the plurality of vacuum suction apertures are separated by a sealing grid.

11. The material handling tool as recited in claim 10, wherein the sealing grid is made of resilient deformable material.

12. The material handling tool as recited in claim 1, wherein the longitudinally movable jaw assembly includes a pair of slides mounting the second jaw member to the body.

13. The material handling tool as recited in claim 12, wherein the longitudinally movable jaw assembly includes an actuator so mounted between the second jaw member and the body to longitudinally move the second jaw member.

14. The material handling tool as recited in claim 13, wherein the actuator is selected from the group consisting of pneumatic actuators, hydraulic actuators and linear motors.

15. The material handling tool as recited in claim 1, further comprising a distance sensor so configured as to determine the distance between the first and second contacting surfaces when the second jaw member is in the extended position.

16. The material handling tool as recited in claim 1, further including a laser sensor so mounted to the longitudinal body as to determine the distance between the body and an object to be manipulated.

17. The material handling tool as recited in claim 1, further including an area scan camera.

18. The material handling tool as recited in claim 1, further including a controller so connected to the vacuum jaw assembly and to the longitudinally movable jaw assembly as to control their operation.

19. The material handling tool as recited in claim 1, wherein the second object contacting surface is defined by a friction pad.

20. The material handling tool as recited in claim 19, wherein the friction pad is removable mounted to the second jaw member.

21. The material handling tool as recited in claim 1, wherein the vacuum jaw assembly further includes a third jaw member provided with a third object contacting surface; the third jaw member being so mounted to the vacuum jaw assembly that the third object contacting surface is generally perpendicular to the first object contacting surface.

22. The material handling tool as recited in claim 21, wherein the third object contacting surface includes at least one vacuum suction aperture.

23. The material handling tool as recited in claim 21, wherein the third jaw member is movable in a direction generally perpendicular to the first object contacting surface.

24. A method to extract from a pallet a first boxed-shaped object provided with two opposite and generally parallel sides using a material handling tool provided with a longitudinal body, a transversally movable vacuum jaw assembly mounted to the body and a longitudinally movable jaw assembly so mounted to the body as to be movable between a retracted position and an extended position where the longitudinally movable jaw assembly faces the vacuum jaw assembly, the method comprising:
i) contacting one of the two opposite sides with the transversally movable vacuum jaw assembly;
ii) applying a vacuum between the vacuum jaw assembly and the one of the two opposite sides;
iii) moving the longitudinally movable jaw assembly from the retracted position to the extended position where the longitudinally movable jaw assembly is generally parallel to the other of the two opposite sides;
iv) transversally moving the vacuum jaw assembly to force a contact between the longitudinally movable jaw assembly and the other of the two opposite sides;
v) moving the body of the tool to thereby extract the first boxed-shaped object maintained between the jaw assemblies.

25. A method as recited in claim 24, wherein the first boxed-shaped object is located adjacent a second boxed-shaped object, the method further comprising moving the body of the tool so as to separate the other of the two opposite sides from the second adjacent boxed-shaped object.

26. A method to position a boxed-shaped object in a pallet including at least two adjacent boxed-shaped objects each provided with two opposite and generally parallel sides; the method using a material handling tool provided with a longitudinal body, a transversally movable vacuum jaw assembly mounted to the body and a longitudinally movable jaw assembly so mounted to the body as to be movable between a retracted position and an extended position where the longitudinally movable jaw assembly faces the vacuum jaw assembly, the method comprising:
gripping the boxed-shaped object to be positioned between the vacuum jaw assembly and the longitudinally movable jaw assembly; one of the two opposite sides being contacted by the vacuum jaw assembly and maintained thereon by a vacuum, and the other of the two opposite sides being contacted by the longitudinally movable jaw;
moving the body of the tool so as to generally position the boxed-shaped object in the desired position in the pallet;
transversally moving the vacuum jaw assembly to force a separation between the longitudinally movable jaw assembly and the other of the two opposite sides;
moving the longitudinally movable jaw assembly from the extended position to the retracted position;
moving the body of the tool to thereby position the boxed-shaped object adjacent to other boxed-shaped object;
removing the vacuum between the vacuum jaw assembly and the one of the two opposite sides; and
moving the body of the tool away from the positioned boxed-shaped object.
